(19) United States
(12) Patent Application Publication
(10) Pub. No.: US 2026/0289394 A1
(43) Pub. Date: Sep. 24, 2026

(54) Reward-Based Training of an Interest-Generating Model for use in Retrieving Items

(71) Applicant: Microsoft Technology Licensing, LLC, Redmond, WA (US)

(72) Inventors: Yufan ZHAO, Redmond, WA (US); Tao DI, Newcastle, WA (US); Jikun LIU, Redmond, WA (US)

(73) Assignee: Microsoft Technology Licensing, LLC, Redmond, WA (US)

(21) Appl. No.: 19/087,412

(22) Filed: Mar. 21, 2025

(51) Int. Cl. G06N 20/00; G06F 18/214; G06Q 30/0242

(52) U.S. Cl. CPC G06N 20/00; G06F 18/214; G06Q 30/0246

(57) ABSTRACT

A technique trains an interest-generating model that maps activity data to a set of candidate interest key phrases. The activity data describes prior action in interacting with computer-implemented services. Once trained, the interest-generating model is used to select and serve items. The technique for training reduces noise in its output results by first filtering the activity data using a filtering model, to produce filtered activity data. The technique then trains the interest-generating model to produce key phrases that are effective in both (1) expressing the interests underlying the filtered activity data and (2) retrieving items from a retrieval engine that are likely to consumed when served, given the identified interests. The technique accomplishes the above goals using reward-based training, which involves scoring candidate interest key phrases based on their effectiveness in retrieving relevant items, and fine-tuning the interest-generating model based on the scored candidate interest key phrases.

### BACKGROUND

Some existing retrieval applications identify relevant items based on the semantic similarity between a query and each candidate item. For example, a vector-based retrieval application uses a neural network to map a query and a candidate target item to first and second distributed vectors, and then compares the two vectors using some type of similarity metric (such as cosine similarity). While useful, these types of retrieval applications sometimes identify items that reflect only superficial relations between queries and target items. In this circumstance, the output of the retrieval application includes noise that does not lead to meaningful engagement with items.

### SUMMARY

A technique is described herein for training an interest-generating model that maps activity data to a set of candidate interest key phrases (IKPs). The activity data describes actions taken by users in interacting with one or more computer-implemented services. The interest-generating model, once trained, is used by an item-serving system. The item-serving system selects and serves items for each user based on the user's assessed interests, as derived from actions taken by the user in interacting with the one or more computer-implemented services.

The technique for training the interest-generating model reduces noise in its process using two strategies. First, the technique performs a preliminary step of filtering the activity data using a filtering model, to produce filtered activity data. Second, the technique trains the interest-generating model to produce candidate IKPs that are effective in both (1) expressing valid interests underlying the filtered activity data and (2) retrieving items from a retrieval system that are most likely to be consumed, given the identified interests. This training effectively aligns two informational spaces: a first described by the filtered activity data and a second described by an index of the retrieval system and associated consumption metrics. The index identifies what items are available and the consumption metrics provide information regarding the prior consumption of those items.

According to some implementations, the technique accomplishes the above goals using reward-based training to train the interest-generating model. The reward-based training involves scoring candidate IKPs based on their effectiveness in retrieving relevant items. The reward-based training then fine-tunes the interest-generating model based on the scored candidate IKPs.

According to some implementations, the technique generates each reward score by based on the combination of two or more sub-scores produced by two or more respective reward models. For example, a first reward model assigns a first sub-score to a candidate IKP based on the click-through-rate of at least one item that matches a candidate IKP. A second reward model assigns a second sub-score to the candidate IKP based on the semantic agreement between the candidate IKP and at least one item that matches the interest. A third reward model assigns a third sub-score that expresses an amount of noise associated with the candidate IKP.

Overall, the technique is effective in reducing noise in the items delivered to users, e.g., by reducing the presence of target items that do not match the actual interests of users. By reducing noise, the technique increases productive and efficient engagement with the retrieval system.

The technique also determines interests of users based on their actions in interacting with the one or more computer-implemented services. In this process, the technique ensures that noise in the activity data is removed or reduced. This approach provides a more comprehensive basis for determining the interests of a user than examining a single query or user profile metadata.

The above-summarized technology is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows an item-serving system for serving items that reflect the interests of a user. The item-serving system uses an interest-generating model to generate interest key phrases (IKPs) based on activity data collected from one or more computer-implemented services.

FIG. 2 shows a training process performed by a training system of FIG. 1 that trains the interest-generating model.

FIG. 3 shows a prompt that the training process of FIG. 2 uses to instruct a language model to remove noise from activity data.

FIG. 4 shows a prompt that the training process of FIG. 2 uses to instruct the language model to generate IKPs.

FIG. 5 shows a machine-trained reward system for scoring IKPs in the training process of FIG. 2.

FIGS. 6-8 show training processes for training respective reward models for use in the reward system of FIG. 5.

FIG. 9 shows a training process for generating training examples, and for training the interest-generating model of FIG. 1 based on the training examples.

FIG. 10 shows a direct preference optimization (DPO) process for training the interest-generating model in the training process of FIG. 2.

FIG. 11 shows a proximal policy optimization (PPO) process for training the interest-generating model in the training process of FIG. 2.

FIG. 12 shows an illustrative language model for implementing the interest-generating model and various other models used in the training process of FIG. 2.

FIG. 13 is a flowchart that provides an overview of the operation of the training system of FIG. 1.

FIG. 14 is a flowchart that provides an overview of the operation of the item-serving system of FIG. 1.

FIG. 15 shows computing equipment that, in some implementations, is used to implement the item-serving system and training system of FIG. 1.

FIG. 16 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. The Item-Serving System

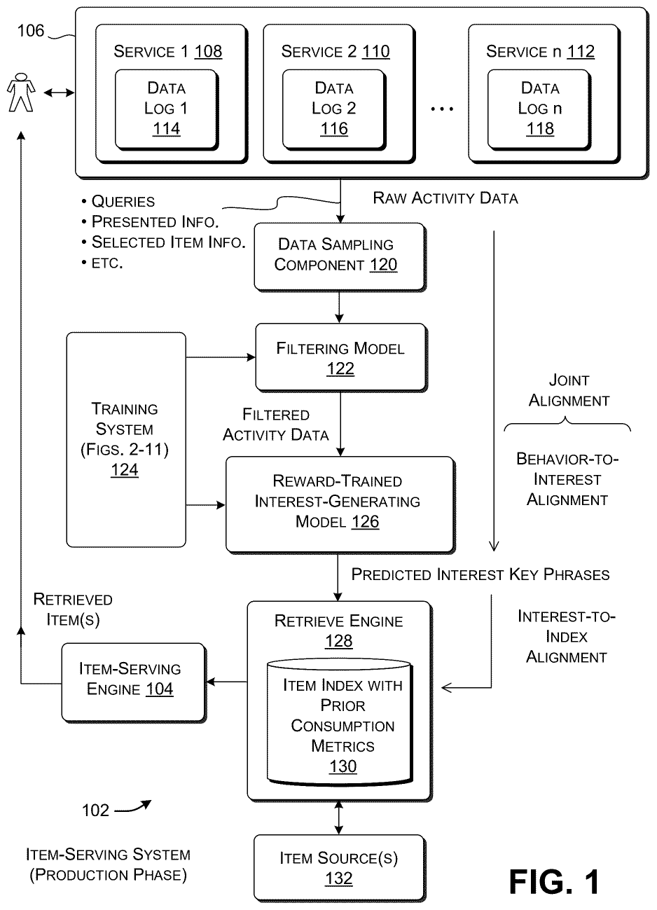

FIG. 1 shows an item-serving system 102 for serving items that reflect the interests of a user. What constitutes an interest-bearing item differs for different implementations. In some implementations, the items represent digital documents, such as news-related articles. Alternatively, or in addition, the items represent digital ads. Alternatively, or in addition, the items represent images and/or videos. Alternatively, or in addition, the items represent songs or other audio files, and so on. Alternatively, or in addition, for at least some items, each item is a multimedia item that combines two or more types of content. For example, items may correspond to image or audio files having textual captions or other metadata.

In some implementations, an item-serving engine 104 first serves information associated with the items, such snippets that provide brief descriptions of the items and/or links (e.g., HTTP links) associated with the items. Alternatively, or in addition, the item-serving engine 104 provides the items themselves. For example, the item-serving engine 104 provides a set of digital ads that match the interests the user. In some examples, the item-serving engine is implemented by a server system and the items (or descriptions thereof) are delivered to a user's computing device via the Internet or other wide area network. In some implementations, the server-system automatically delivers the items (or descriptions thereof) to the user via a personalized website, and/or via Email or some other message.

The operation of the item-serving system 102 will be described in this section in generally a top-down manner. The following terminology is relevant to some examples presented below. In some examples, a “machine-trained model” or “model” refers to computer-implemented logic for executing a task using machine-trained parameters (e.g., filter weights, biases) that are produced in a training operation. In some examples, a “language model” refers to a specific kind of machine-trained model that is initially trained, in part, to predict a next token, given a sequence of preceding tokens. In some examples, a “token” refers to a unit of information processed by a machine-trained model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. In some examples, a “prompt” refers to a sequence of tokens submitted to a machine-trained model. In some examples, a “distributed vector” expresses the semantic content of an information item by distributing information over its k dimensions. In some examples, terms such as “component,” “module,” “engine,” and “tool” refer to parts of computer-based technology that perform respective functions. FIGS. 16 and 16, described below, provide examples of illustrative computing equipment for performing these functions

The user interacts with one or more computer-implemented services 106 for various purposes. For example, a first service 108 represents a search engine (such as the BING search engine provided by Microsoft Corporation of Redmond, Washington), a second service 110 represents a browser application (such as the EDGE browser provided by Microsoft Corporation), and a third service 112 represents a website (such as the MSN website provided by Microsoft Corporation) that provides access to a specific collection of information-bearing items (e.g., news articles) and other functionality. This set of computer-implemented services is illustrative; other implementations may extract information from a different combination of services, including any application with which the user interacts (e.g., word processing applications, spreadsheet applications, Email applications). The function of a service may be entirely implemented by a local computing device, entirely implemented by a server system (with which the user interacts via a local browser application or the like), or implemented by a combination of local and server-side resources.

Each of these services 106 stores information in a log that describes interactions with each user. For example, the first service 108 includes a data log 114 that describes queries submitted by the user in interacting with a search engine, and information sent to the user in response to those queries, e.g., by storing the title of articles delivered to the user in a search results page and/or information extracted from the URL addresses of the articles. This data log 114 also identifies the selections made by a user in response to receiving the information, e.g., by storing titles of the articles selected, portions of URL addresses of articles selected, and so on. Similarly, the second service 110 provides a second data log 116, and the third service 112 provides a third data log 118, each of which can contain the same types of information as the first data log 114. Collectively, the data in the data logs (114, 116, 118) is referred to as activity data because it reflects the actions that the user has taken in interacting with the various computer-implemented services 106.

A data-sampling component 120 extracts initial (or raw) activity data from the computer-implemented services 106. For example, the data-sampling component 120 produces a set of initial activity data that describes a predetermined number of the most recent actions taken by the user within a prescribed timeframe, such as the last six months or the last year. The initial activity data includes a subset of activity data that reflects the actual interests of the user and another subset of activity data that is not effective in revealing the interests of the user, in which activities of the two subsets are mixed together.

The second subset of activity data represents noise. For example, queries such as “/s”,” “ggg,” “aaayyy,” “3*2+4,” “4257898789,” “150 Baker Steet, Spokane, WA,” “google docs,” and “amazon” are not meaningful queries because they were likely submitted with the intent to perform specific transactions in the course of interacting with various applications, rather than to obtain information that reflects a persistent topic with which the user evinces an interest. In contrast, a query such as “What state is the best to retire” may reflect an abiding interest, not limited to a specific transaction. All data associated with user activity is sanitized (e.g., by hashing) to remove or obscure private information. Further, the item-serving item provides configuration functionality that allows each individual user to opt in and out of the collection of activity data, and to control the retention/deletion of the activity data once collected.

A filtering model 122 reduces the amount of noisy activity data in the initial activity data, to produce filtered activity data. In some implementations, a training system 124 produces the filtering model 122 by fine-tuning a pretrained language model, such as a BERT-type language model. This type of filtering model 122 maps tokens associated with each activity to hidden state information, and then uses a classification head to classify the activity as noise or not-noise. General background information on BERT-based technology is available at Devlin, et al., “BERT: Pre-training of Deep Bidirectional Transformers for Language Understanding,” arXiv, arXiv:1810.04805v2 [cs.CL], May 24, 2019, 16 pages. Other implementations use other types of machine-trained models (e.g., convolutional neural networks) to perform the same task. In some implementation, and as will be described in Section B, the training system 124 trains the filtering model 122 based on training examples generated using a larger and more accurate language model.

An interest-generating model 126 maps each activity in the filtered activity data to one or more interest key phrases (IKPs). Each IKP includes one or more words that express a topic of interest. For example, for the query “What state is the best to retire,” the interest-generating model 126 may identify an IKP “retirement planning” and an IKP “cost of living.”

In some implementations, the training system 124 produces the interest-generating model 126 by fine-tuning a pretrained language-based model. For example, the pretrained language-based model may correspond to the a relatively small-sized and efficient language model, such as the Mistral language model having 7B parameters described in Jiang, et al., “Mistral 7B,” arXiv, arXiv:2310.06825v1 [cs.CL], Oct. 10, 2023, 7 pages. The interest-generating model 126 produced thereby autoregressively maps each activity in the filtered activity data to one or more IKPs. Autoregressive means that the interest-generating model 126 successively produces each token of a response, appending each token that is generated in a particular pass to the end of a sequence of input tokens to be submitted to the interest-generating model 126 in a next pass. This iterative process ends when the interest-generating model 126 predicts a stop token. In some examples, the training system 124 trains the interest-generating model 126 based on training examples generated using a larger language model

More specifically, the training system 124 uses some form of reward-based training to fine-tune the interest-generating model 126. As will be described in Section B, the reward-based training process uses a machine-trained reward system to assign scores to the IKPs. Each score assigned to an IKP describes the IKP's effectiveness in identifying available items that will interest the user, given the predicted interests of the user. The reward system computes each score based on plural sub-scores generated by respective machine-trained reward models.

Once trained, the interest-generating model 126 can be said to serve a dual objective. On the one hand, the interest-generating model 126 produces IKPs that match actual interests of the user, as reflected in the filtered activity data. At the same time, the interest-generating model 126 produces IKPs that will result in the retrieval of items that are likely to be selected (e.g., clicked on) by the user. In other words, the interest-generating model 126 produces IKPs that align with both an informational space associated with the filtered activity data and informational space associated with an index 130 of the retrieval engine 128 and associated metrics describing prior consumption of items identified in the index 130. That is, the index 130 identifies what items are available to be served to users, and the consumption metrics describe the extent to which those items have been consumed (e.g., clicked on) in the past.

The use of the interest-generating model 126 to retrieve items differs from a conventional semantic-based retrieval approach. In such an approach, a retrieval engine maps directly maps a submitted query to a semantic embedding, treating the given form of the query as an accurate indication of the user's search objective. A conventional retrieval engine then makes retrieval decisions based on this semantic embedding. For instance, using this approach, a retrieval engine may attempt to match a query which mentions a specific celebrity wearing a specific fashion brand to content that pertains to the name of that fashion brand and/or the name of the celebrity. But such a search strategy may fail to identify a sufficient number of items that are actually available that may be served to the user. In addition, or alternatively, such a search strategy may lead to the delivery of items that fail to pique the interest of the user. To address this issue, in some cases, the interest-generating model 126 described herein will rewrite the query to a more general IKP which simultaneously reflects at least one deep interest of the user and which will lead to meaningful engagement with the served items. For example, the interest-generating model 126 may rewrite the submitted query to the IKP “celebrity fashion” and/or the IKP “fashion trends in Hollywood.”

The retrieval engine 128 retrieves a set of items based on a set of IKPs generated by the interest-generating model 126. The retrieval engine 128 can use different approaches to perform lookup, including a lexical-based lookup (e.g., keyword-based lookup), feature-based lookup, semantic based lookup (e.g., using an approximate nearest neighbor technique), etc., or any combination thereof. Different implementations of the retrieval engine retrieve the items from different item sources 132. For example, the item sources 132 represent a data store that provides a curated collection of items, such as news items. In other examples, the item sources 132 represent a more distributed collection of available items provided by the Internet or other wide area network.

The item-serving engine 104 provides a prescribed number of selected items to the user. For example, the item-serving engine 104 selects 50 items to present to the user, e.g., including five items for each of ten categories. The item-serving engine 104 provides the items to the user in different respective forms. In some implementations, the item-serving engine 104 provides a list of snippets that describe the items. In other implementation, the item-serving engine 104 provides the items themselves, e.g., by providing ads identified by the retrieval engine 128.

The item-serving system 102 is technically beneficial because it reduces the amount of low-quality items that are served to users. Low-quality items clutter users interface presentations with useless information, which impedes interaction by the users with computing devices and applications. The item-serving system 102 also enables users to more quickly converge on items that match their actual interests. From the system-provider perspective, increasing the efficiency of item delivery has the effect of reducing the use of memory, processor, and communication resources. This is because, by more quickly converging on relevant items, the item-serving system 102 reduces the number of transactions that are performed in serving items.

The technique also extracts activity data from logs of computer-implemented services 106, which is then processed to provide an accurate indication of the interests of a user, while also ensuring that noise in the activity data is removed. This approach provides a more comprehensive basis for determining the interests of a user than, for example, examining a single query or user profile metadata.

### B. The Training System

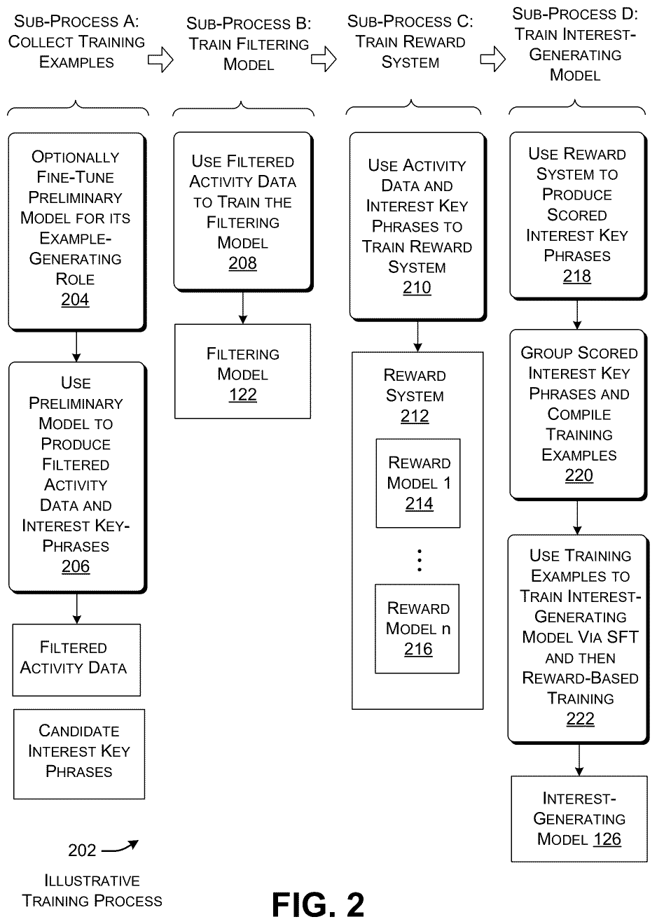

FIG. 2 shows a training process 202 performed by the training system 124 of FIG. 1 that trains the interest-generating model 126. In this particular example, the training system 124 performs plural sub-processes (A, B, C, and D) in producing the interest-generating model. Other implementations adopt other training approaches. For example, another approach trains at least some of the different models described below in an integrated end-to-end fashion, rather than, as shown in FIG. 2, in a staged manner, in which the trained models produced in one phase are fixed or frozen in a subsequent phase.

In an operation 204 of sub-process A, the training system 124 produces a preliminary model by fine-tuning a publicly available pre-trained language model, such as the Qwen model or the LLaMa model. General information about the Qwen model is available at Yang, et al., “Qwen2.5 Technical Report,” arXiv, arXiv:2412.15115v2 [cs.CL], Jan. 3, 2025, 26 pages. Information regarding the LLAMA model is available at Touvron, et al., “LLaMA: Open and Efficient Foundation Language Models,” arXiv, arXiv:2302.13971v1 [cs.CL], Feb. 27, 2023, 27 pages. The preliminary model, once trained, runs on a local system, without exposing activity data to a third party. The training system 124 can fine-tune the pretrained language model using any combination of techniques, such as the Chain-of-Thought (CoT) technique, reward-based learning, etc. General information regarding the CoT technique is described in Wei, et al., “Chain-of-Thought Prompting Elicits Reasoning in Large Language Models,” arXiv, arXiv:2201.11903v6 [cs.CL], Jan. 10, 2023, 43 pages.

For example, the training system 124 trains the pretrained language model based, in part, on publicly available math-related training examples and code-related training examples. The training system 124 produces loss information for a math-related training example by comparing a model-generated answer with an accepted ground-truth answer (given by the training example). The training system 124 produces loss information for a code-related training example by comparing model-generated code with verification results produced by a compiler. In other examples, the training system 124 uses an already fine-tuned language model as the preliminary model, such as any large language model provided by OpenAI of San Francisco, California.

In operation 206, the training system 124 uses the preliminary model, once trained, to generate training examples, which are then used to train the filtering model 122 and the interest-generating model 126 actually used in the item-serving system 102. In this context, the preliminary model serves as a cold start model, the function of which is to provide training examples which bootstrap the training process. In some examples, the eventual filtering model 122 and interest-generating model 126 produced by the training process 202 are smaller and more efficient than the preliminary model. The training system 124 produces the training examples based on a collection of activity data produced by a group of users, appropriately sanitized. Such data is also referred to as group activity data to distinguish it over user activity data that is associated with an individual user

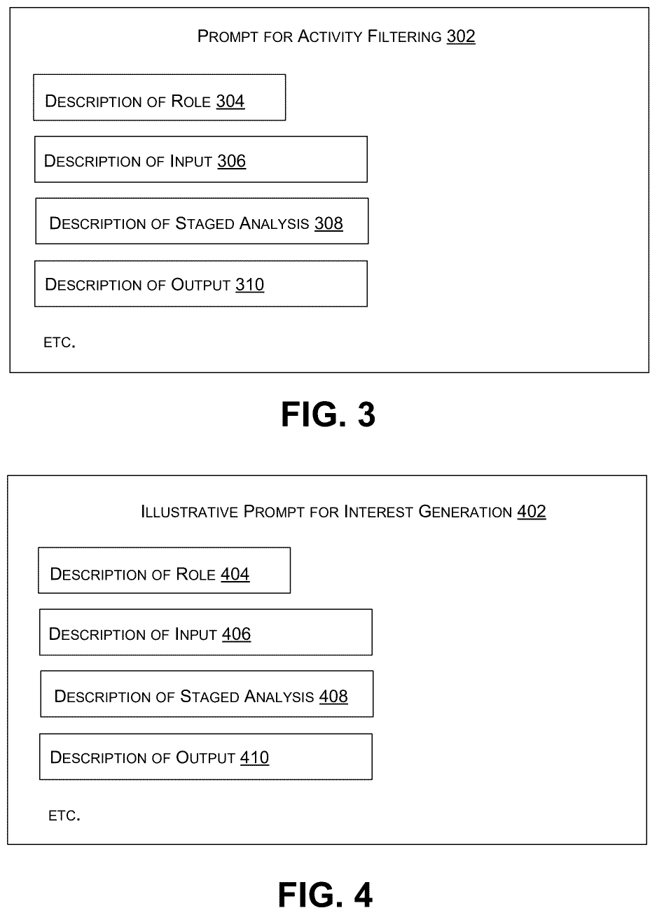

More specifically, in some examples, the training system 124 produces filtered activity data using the preliminary model based on the illustrative prompt 302 shown in FIG. 3. This particular prompt 302 instructs the preliminary model to map a search query to a score that describes the likelihood that the query matches an interest a user. The prompt 302 begins with a section 304 that defines the role of the preliminary model in performing a filtering role. As illustrative definition is: “Your responsibility is to evaluate search queries extracted from a search engine log using a refined 3-Score system. The goal is to assess the informativeness of the query and uncover potential user interests. Ultimately, this evaluation aims to make personalized judgments regarding the correlation between user interests and recommended news.” A next section 306 defines the input data that is fed to the preliminary model. For instance, this section asks the preliminary model to expect queries and news items that were displayed to users in response to those queries.

A next section 308 asks the preliminary model to increment a score in stages, in which the prompt 302 defines the criteria for assigning a point in each such stage. An illustrative prompt 302 describes three stages as follows. “Total Score 1: Award 1 score if the search query contains meaningful information.” “Examples that fail to satisfy this specific criterion: Numeric strings (e.g., ‘3*2+4’), Gibberish (e.g., ‘gejn jhewb’). “Total Score 2: Allocate an additional score if the informative search query indicates potential alignment with the user's personal interests.” “Examples that fail to satisfy this specific criterion include: navigational queries (e.g., ‘Facebook,’ ‘Gmail login,’ ‘Youtube’); vague queries (e.g., ‘energy,’ ‘history’); generic news queries (e.g., ‘bbc news,’ ‘CNN,’ ‘The Guardian’); general geographical information (not attractions): (e.g., ‘150 Lynch Road, Chaplin, CT’); common names (not celebrity): (e.g., ‘jack,’ ‘david’). “Total Score 3: Grant a third score if the recommended news successfully engages the user.” “Examples that fail to satisfy this specific criterion: News that is irrelevant to user search query (e.g., search query: ‘How to bake a cake’ with news ‘Stock Market Plummets Amidst Political Unrest’). News that is semantically relevant to user search query, but the user will not be interested in (e.g., search query: ‘upcoming Marvel movie releases’ with news ‘Interview with the Director of a Romantic Comedy’).” Section 308 includes the following illustrative general instructions: “Evaluate the search query based on its informativeness and potential alignment with the user's interests. Provide a brief analysis regarding each specific criterion, and finally provide the assigned score.” Further, “You should analyze step by step according to each specific criterion defined above.” A final section 310 describes how the preliminary model should structure the results of its analysis.

In some examples, the preliminary model produces candidate IKPs based on filtered activity data using the prompt 402 shown in FIG. 4. This particular prompt 402 begins with a section 404 that defines the role of the preliminary language model in performing the interest-mapping task. An illustrative description of the role is: “Your role is to recommend key phrases for retrieving mainstream news articles based on a user's search history, clicked news articles, and browsing activity on the browser. Analyze the user's behaviors to identify their interests in current events. Generate a variety of key phrases that are likely to help find additional engaging mainstream news articles using the news search engine.” This section may also describe the desired properties of the candidate IKPs. Illustrative requirements are: “1. Use key phrases to highlight relevant and reputable news content for users . . . ” “2. Make key phrases diverse, original, and non-repetitive.” “3. Reflect the user's interests, preferences, and habits based on their previous interactions.” “4. Choose key phrases that are specific, use more than three words to avoid confusion and vagueness.” “5, Avoid key phrases that direct to non-news content, such as tutorials, documents.” “6. Filter out non-personalized search queries that may not capture the user's true interests.” A next section 406 defines the input data that the preliminary model will be expected to analyze.

In section 408, the prompt 402 then instructs the preliminary language model to generate the candidate IKPs in a structured manner, “step by step,” e.g., by first summarizing user actions into ten distinct and evidence-supported aspects, and then providing a concise list of twenty diverse and relevant candidate IKPs derived from the user's behavior. A last section 410 instructs the preliminary model to structure its output in a prescribed manner. An illustrative format instruction is: “Format: ‘summarization’: {(aspect 1: reason 1, aspect 2: reason 2, aspect 3: reason 3, . . . }), ‘key phrases’: (key phrase 1, key phrase 2, key phrase 3, . . . )}.

Returning to FIG. 2, in operation 208 of sub-process B, the training system 124 uses the filtered activity data produced in sub-process A to train the filtering model 122. As previously stated, one implementation of the filtering model 122 is a BERT-based language model. In some implementations, the training system 124 uses supervised fine-tuning to train the filtering model 122, e.g., by generating loss information that describes the difference between model-generated filtering results and ground-truth filtering results provided by the preliminary model, and then using stochastic gradient descent to update the parameters of the filtering model 122.

In operation 210 of sub-process C, the training system 124 uses the candidate IKPs produced by the preliminary model to train a reward system 212. More specifically, the training system 124 trains plural reward models (214, . . . , 216) used by the reward system 212 in a manner described below with reference to FIGS. 8-10. In some implementations, each reward model is a relatively light-weight language model of any type, e.g., having one billion parameters.

In operation 218 of sub-process D, the training system 124 uses the trained reward system 212 to generate a score for each candidate IKP that describes the effectiveness of the IKP in retrieving relevant items. The score is some combination of the sub-scores produced by the reward system's individual reward models (214, . . . , 216). This operation yields scored IKPs.

In operation 222, the training system 124 organizes the scored IKPs into groups. Each group contains scored IKP that are semantically similar as assessed by any similarity metric (e.g., cosine similarity) and any threshold setting. Each scored IKP is associated with a query or other type of user activity. In some implementations, the training system 124 then selects two samples from each group having significantly different reward scores. For example, the training system 124 chooses the query/IKP pair having the best (e.g., highest) reward score as a positive sample, and chooses the query/IKP pair having the worst (e.g., lowest) reward score as a negative sample. The training system 124 then produces a plurality of training examples, each including a positive sample and a negative sample. In other implementations, the training system 124 only chooses a single positive example from each group.

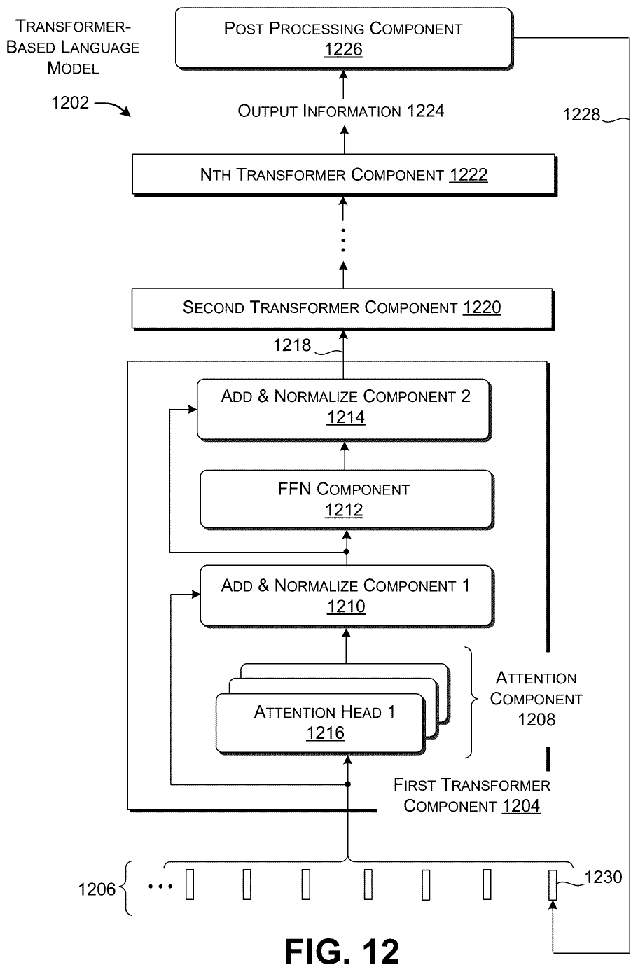

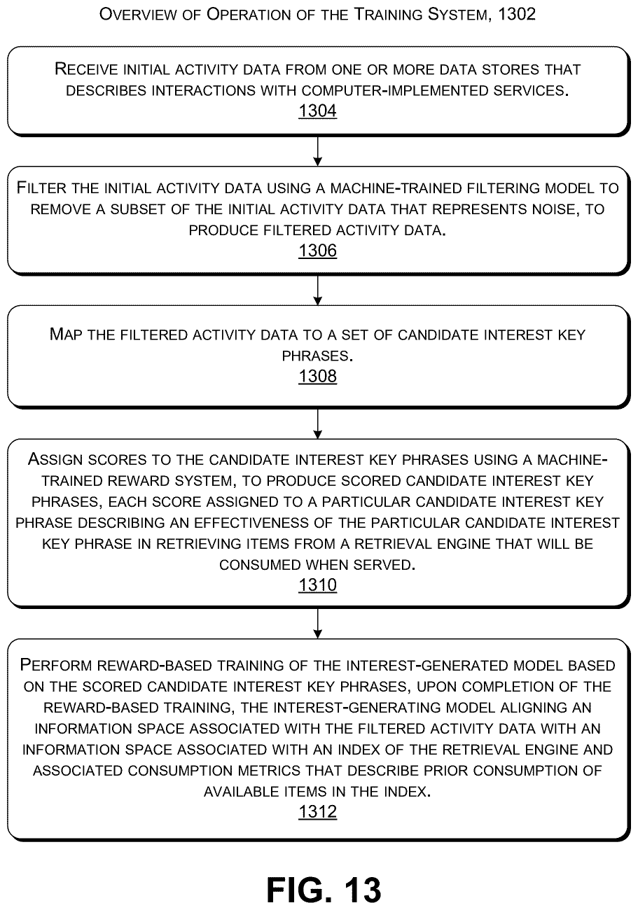

In operation 222, the training system 124 trains the interest-generating model 126 based on the training examples produced in operation 220. In some examples, the interest-generating model 126 in its original form represents a pretrained language model, such as the Mistral 7B model. In some implementations, the training system 124 trains the interest-generating model 126 using supervised fine-tuning (SFT) followed by any type of reward-based training. The training system 124 performs SFT by generating loss information that measures the difference between model-generated IKPs and ground-truth IKPs (produced by the preliminary model). The training system 124 performs reward-based training in various ways, such as the ways described below in the context of the explanation of FIGS. 12 and 13.

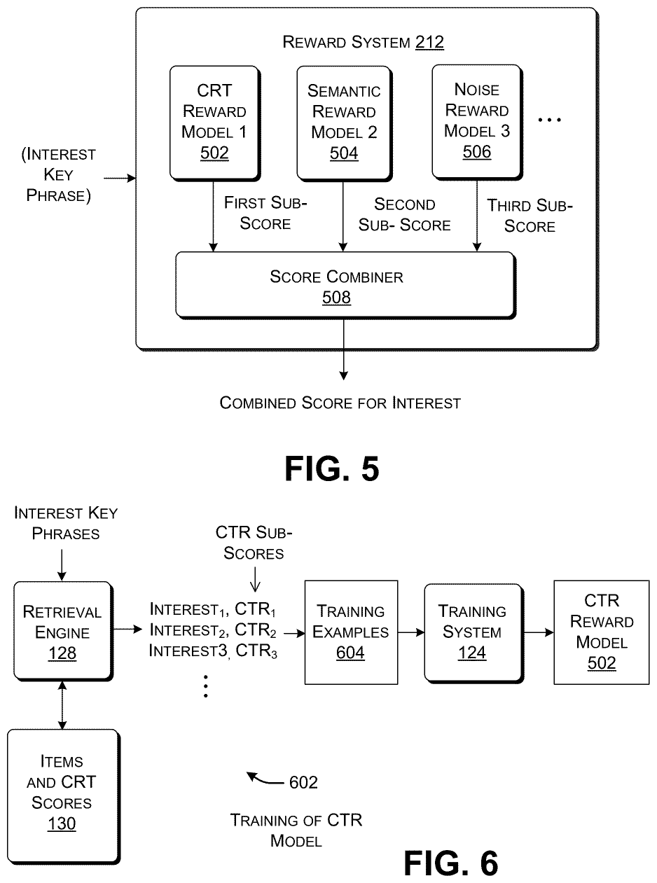

FIG. 5 shows one implementation of the reward system 212. The reward system 212 maps an input IKP into a reward score. A click-through-rate (CTR) reward model 502 produces a first sub-score that describes CRT information or other engagement information associated with one or more items retrieved on the basis of the input IKP. A semantic reward model 504 produces a second sub-score that describes the semantic agreement between the input IKP and one or more items retrieved on the basis of the IKP. The semantic reward model 504 can also be referred to as an index-matching model, since it describes the extent to which an IKP matches items in the index 130. A noise reward model 506 produces a third sub-score that indicates whether the IKP represents noise. A score combiner 508 combines the sub-scores to form a single reward score. For example, the score combiner 508 produces an average or weighted average of the separate sub-scores, or produces the score using a machine-trained mapping model.

Note that the filtering model 112 removes noise from the initial activity data, while the noise reward model 506 is used to remove noise from candidate IKPs. In a larger context, all of the reward models can be said to serve a role in identifying the most useful IKPs and reducing the least useful IKPs.

Other implementations use a different combination of reward models than described above. For example, another implementation uses a model that measures the extent to which each IKP is common among a collection of documents. One such metric for making this assessment is term frequency-inverse document frequency (TF-IDF). A TF-IDF reward model would give a low score to queries such as “google,” but a higher score to queries such as “Sundar Pichai bio.”

FIG. 6 shows a training process 602 for training the CRT reward model 502. Advancing from left to right, the retrieval engine 128 retrieves one or more items from the data store 132 that are the closest matches to each candidate IKP, as determined by any matching criteria, such as lexical-based matching (e.g., keyword-based matching), feature-based matching, and/or semantic-based matching. In some implementations, the index 130 or some other log provides information regarding the click-through-rate (CTR) of each item that is retrieved. A click-through-rate describes the percentage of times that users have clicked the item, relative to the total number of times that the item was presented to the users (i.e., the number of impressions). In some examples, the training process 602 produces a single CTR sub-score for a candidate interest by averaging the individual CRT metrics associated with two or more items that are retrieved for the IKP. Other implementations use any other metric or combination of metrics to determine the usefulness of an IKP in motivating clicks, such as conversion rate. The training process 602 produces a plurality of training examples 604 based on scored IKPs. That is, each training example includes an IKP and its average CRT sub-score. The training system 124 trains the CRT reward model 502 based on the training examples 604, e.g., using supervised fine-tuning and/or any other training approach.

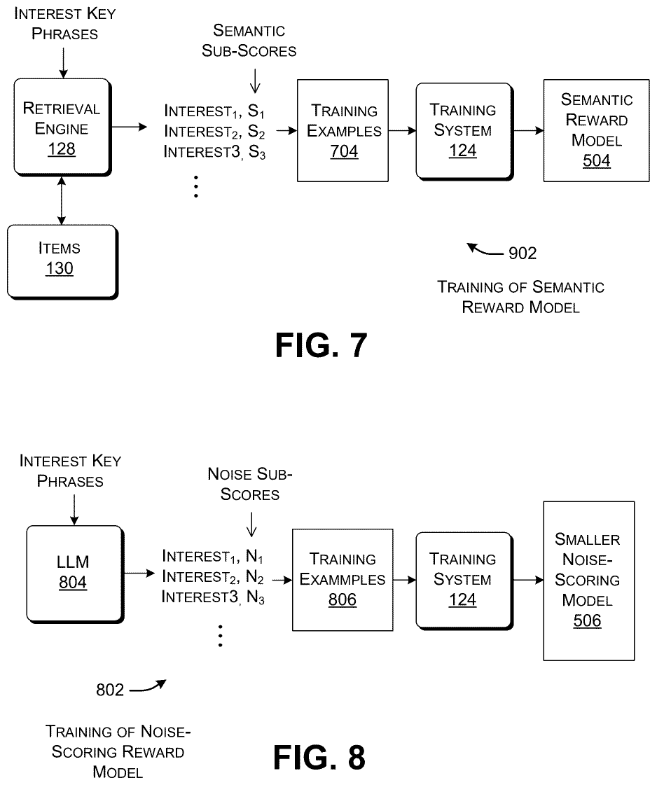

FIG. 7 shows a training process 702 for training the semantic reward model 504. The retrieval engine 128 identifies one or more items that are the closest semantic matches to each IKP. For example, to determine the semantic similarity between the IKP and a particular item, the training process 702 uses a neural network of any type to map the IKP and the item to respective distributed vectors, and then uses any type of similarity metric (such as cosine similarity) to determine the similarity between the two vectors. In some implementations, the index 130 of the retrieval engine 128 already stores a semantic embedding for each target item, and the retrieval engine 128 matches an input semantic embedding with the target item embeddings using, for instance, the approximate nearest neighbor (ANN) technique. In some examples, the training process 702 produces a single semantic sub-score for a candidate interest by averaging the individual semantic sub-scores associated with plural items that are retrieved based on the IKP, or by selecting the maximum of the individual semantic sub-scores, etc. The training process 702 produces a plurality of training examples 704 based on the scored IKPs. That is, each training example includes an IKP and its semantic sub-score. The training system 124 trains the semantic reward model 504 based on the training examples 704, e.g., using supervised fine-tuning and/or any other training approach.

FIG. 8 shows a training process 802 for training the noise reward model 506. A language model 804 maps each IKP to a binary noise score or a probability within the range of 0 to 1 that indicates whether or not the IKP represents noise. The language model 804 performs this task based on a submitted prompt that instructs it how to interpret the IKP, such as the type of prompt 302 shown in FIG. 3. This operation yields a plurality of training examples 806, each of which includes an IKP and its computed noise score. The training system 124 trains the noise reward model 506 based on the training examples 806, e.g., using supervised fine-tuning and/or any other training approach. In other examples, the noise reward model 506 is the same model as the filtering model 122.

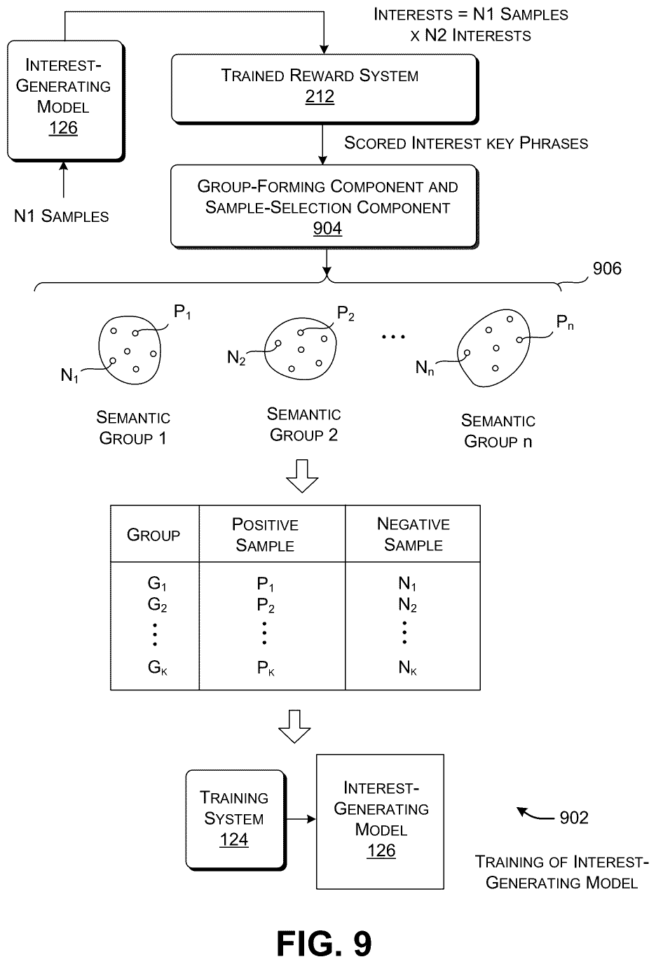

FIG. 9 shows a training process 902 that represents one implementation of sub-process D of FIG. 2, which involves training the interest-generating model 126 using the trained reward system 212. First, the training process 902 selects a number (N1) of activities (e.g., queries) from the filtered activity data, such as 50 queries. For each such activity, the interest-generating model 126 produces N2 candidate IKPs (e.g., 5 candidate IKPs). The interest-generating model 126 controls the randomness in its selection of output tokens by choosing appropriate configuration parameters, e.g., by setting the temperature parameter (T) to t=1 and setting the top_p parameter value to top_p=1. The temperature parameter (T) is used in the exponential of the interest-generating model's Softmax calculation (e.g., e^{(z}^{ᵢ}^{/τ)}), while the top_k parameter controls the size of the vocabulary used to sample output tokens. These configuration choices lead to the generation of a total of N1×N2 candidate IKPs. The training process 902 then uses the trained reward system 212 to score each candidate IKP, to produce scored IKPs.

A group-forming component 904 groups the scored IKPs into a plurality of groups 906. For example, the group-forming component 904 uses any type of clustering algorithm to cluster the scored IKPs based on their semantic similarity, e.g., where the difference between any two IKPs is computed using cosine similarity or any other similarity metric. Each group includes a set of semantically similar IKPs.

In some examples, the training process 902 then chooses a representative positive sample and a representative negative sample from each semantic group, e.g., by choosing the IKP having the best reward score (for the positive sample) and the IKP having the worst reward score (for the negative sample). Each sample is also associated with a query on the basis of which the interest-generating model 126 generated the IKP. The training process 902 produces a plurality of training examples based on these samples, each including a pair of positive and negative samples. In other implementations, the training process 902 only chooses a positive sample from each group.

The training system 124 fine-tunes the interest-generating model 126 using any reward-based training technique such as direct preference optimization (DPO), proximal policy optimal optimization (PPO), monolithic preference odds ratio preference optimization (ORPO), and so on.

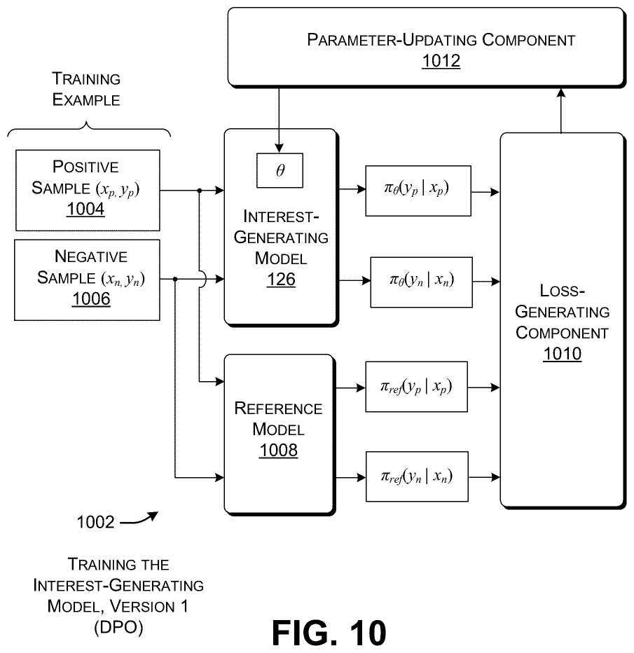

FIG. 10 shows a first reward-based process 1002 for training the interest-generating model 126 based on the use of DPO, which is shown here for a particular training example including a positive sample 1004 (xₚ, yₚ) and a negative sample 1006 (xₙ, yₙ). x represents the input query, and y represents the generated interest. Each sample is also associated with a reward score. The subscripts p and n represent positive and negative samples, respectively. The interest-generating model 126 has parameters θ. The interest-generating model 126 maps the positive sample 1004 to a positive model-generated result (π_{θ}(yₚ|xₚ)) and maps the negative sample 1006 to a negative model-generated result (π_{θ}(yₙ|xₙ)). Each model-generated result identifies the likelihood of a given IKP, as assessed by the logits of the interest-generating model 126. A reference model 1008 maps the positive and negative samples (1004, 1006) to positive and negative model-generated result, ((π_{ref}(yₙ|xₙ)) and (π_{ref}(yₙ|xₙ))), respectively. In some examples, the reference model 1008 is a language model before it has been trained by reward-based training, e.g. corresponding to the interest-generating model 126 at the end of SFT but before reward-based training. A loss-generating component 1010 uses the model-generated results to compute loss information, and a parameter-updating component 1012 uses the loss information to update the parameters θ of the interest-generating model 126, e.g., using stochastic gradient descent in combination with back propagation.

In some examples of DPO, the loss-generating component 1010 computes loss L_{DPO} using the following function:

$${L}_{DPO} = - {𝔼}_{( p , n ) ∼ D} [ log σ ( βlog \frac{{π}_{θ} ( {y}_{p} \vert {x}_{p} )}{{π}_{ref} ( {y}_{p} \vert {x}_{p} )} - β log \frac{{π}_{θ} ( {y}_{n} \vert {x}_{n} )}{{π}_{ref} ( {y}_{n} \vert {x}_{n} )} ) ] . \qquad ( 1 )$$

σ represents the logistic function and β is a hyper-parameter. This loss function is based on the use of cross entropy. The loss function is mathematically derived using the Bradley-Terry (BT) model based on an original loss function formulation that expresses loss as a combination of reward loss and Kullback-Leibler (KL) divergence loss. General information regarding the DPO approach is described in Rafilov, et al., et al., “Direct Preference Optimization: Your Language Model is Secretly a Reward Model,” arXiv, arXiv:2305.18290v3 [cs.LG], Jul. 29, 2024, 27 pages.

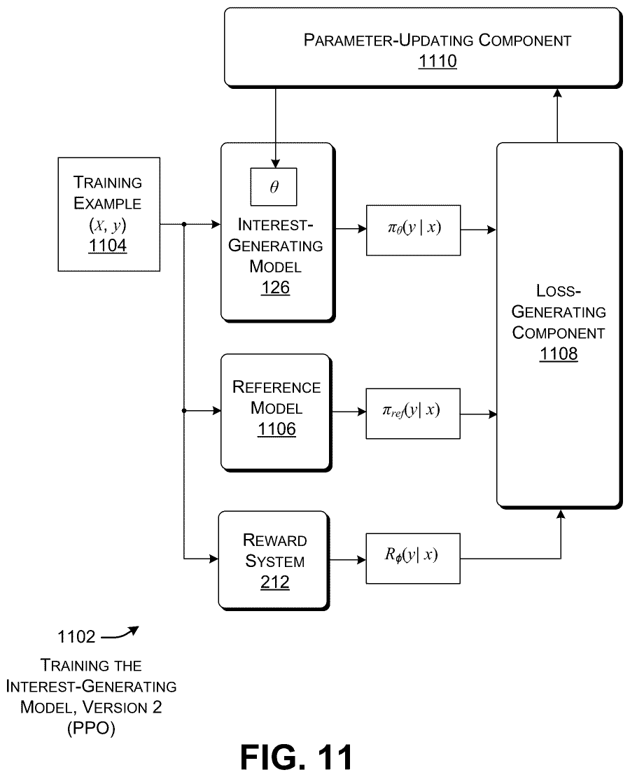

FIG. 11 shows a second reward-based process 1102 for training the interest-generating model 126 based on the use of PPO, which is shown here for a particular training example including a positive sample 1104 (x, y) drawn from a cluster. The interest-generating model 126 has parameters θ. The interest-generating model 126 maps the positive sample 1104 to a first model-generated result (π_{θ}(y|x)), while a reference model 1106 maps the positive sample 1104 to a second model-generated result ((π_{ref}(y|x)). As in the case of FIG. 10, the reference model 1106 is the SFT-trained model prior to performing reward-based training. The trained reward system 212 maps the training example to reward information R_{φ}(y|x). A loss-generating component 1108 uses the model-generated results and reward information to compute loss information, and a parameter-updating component 1110 uses the loss information to update the parameters θ of the interest-generating model 126, e.g., via stochastic gradient descent in combination with back projection.

In some examples of PPO, the loss-generating component 1108 computes loss L_{PPO} using the following function:

$${L}_{PPO} = {𝔼}_{x , y} [ {R}_{ϕ} ( x , y ) ] - β {𝔻}_{KL} [ {π}_{θ} ( y \vert x ) \vert \vert {π}_{ref} ( y \vert x ) ] . \qquad ( 2 )$$

The first part of the equation represents optimization based on the reward information produced by the reward system 212. The second part of the equation represents optimization based on the KL divergence between the response from the interest-generating model 126 and the response from the reference model 1106, respectively. The second part of the equation more generally ensures that the effort to optimize the interest-generating model 126 based on the reward information does not degrade the ability of the interest-generating model 126 to produce correct responses, e.g., as learned in a preliminary SFT process. β is a hyper parameter. General information regarding the PPO approach is provided in Zheng, et al., “Secrets of RLHF in Large Language Models Part I: PPO,” arXiv, arXiv:2307.04964v2 [cs.CL], Jul. 18, 2023, 32 pages.

While the above approaches employ the use of a reference model, other approaches, such ORPO, do not. General information regarding the ORPO approach is available at Hong, et al., “ORPO: Monolithic Preference Optimization without Reference Model,” arXiv, arXiv:2403.07691v2 [cs.CL], Mar. 14, 2024, 22 pages.

The trained interest-generating model 126 is subsequently installed in the item-serving system 102. As shown in FIG. 1, the item-generating model 126 operates in the production stage without reliance on the reward system 212 (which is only used to produce the training examples, on the basis of which the interest-generating model 126 is trained). The interest-generating model 126 has a number of advantageous technical characteristics. First, the interest-generating model 126 has a relatively small size. For example, in one implementation, the interest-generating model 126 has 7B parameters, whereas other large language models have a size of hundreds of billions of parameters. One factor that contributes to the smaller size of the interest-generating model 126 is the manner it was trained. For instance, the interest-generating model 126 is trained using reward-based training based on training examples that express plural reward-based signals. This enables the interest-generating model 126, once trained, to generate accurate interests without duplicating the more complex reasoning processes used by other large language models. In other words, the insight of larger language models can be said to be encapsulated in the training examples that are used to train the smaller interest-generating model 126. The use of a smaller model reduces latency and resource usage compared to larger language models. The resource usage includes processor (e.g., GPU) usage and memory usage. Second, in some implementations, the interest-generating model 126 operates without interacting with third-part language models. This helps protect the privacy of users. Third, the interest-generating model 126 produces accurate interests because it integrates information collected from plural application platforms. This provides a more comprehensive, holistic, and up-to-date understanding of the true interests of a user compared to, for example, a recommendation based on an individual query or a static user profile.

### C. Illustrative Language Model

FIG. 12 shows an illustrative language model 1202 for implementing the interest-generating model 126 and various other models used in the training process 202 of FIG. 2. The language model 1202 is composed, in part, of a pipeline of transformer components, including a first transformer component 1204. FIG. 12 provides details regarding one way to implement the first transformer component 1204. Although not specifically illustrated, other transformer components of the language model 1202 have the same architecture and perform the same functions as the first transformer component 1204 (but are governed by separate sets of weights).

The language model 1202 commences its operation with the receipt of input information, such as a passage of text. The prompt includes a series of linguistic tokens. In some examples, a “token” refers to a unit of text having any granularity, such as an individual word, a word fragment produced by byte pair encoding (BPE), a character n-gram, a word fragment identified by the WordPiece or SentencePiece algorithm, etc. To facilitate explanation, assume that each token corresponds to a complete word. The principles set forth herein, however, are not limited to the processing of text information; in other examples, the language model 1202 operates on any of: audio information, image information, video information, sensor information, and so on, or any combination thereof.

Next, an embedding component (not shown) maps the sequence of tokens into respective token embeddings. For example, the embedding component produces one-hot vectors that describe the tokens, and then maps the one-hot vectors into the token embeddings using a machine-trained linear transformation. The embedding component then adds position information (and, in some cases, segment information) to the respective token embeddings to produce position-supplemented embedding vectors 1206. The position information added to each token embedding describes the embedding vector's position in the sequence of token embeddings.

The first transformer component 1204 operates on the position-supplemented embedding vectors 1206. In some implementations, the first transformer component 1204 includes, in order, an attention component 1208, a first add-and-normalize component 1210, a feed-forward neural network (FFN) component 1212, and a second add-and-normalize component 1214.

The attention component 1208 determines how much emphasis should be placed on parts of input information when interpreting other parts of the input information. The attention component 1208 performs attention analysis using the following equation:

$$Attention ( Q , K , V ) = softmax ( \frac{{QK}^{T}}{\sqrt{{d}_{k}}} ) V . \qquad ( 3 )$$

The attention component 1208 produces query information Q by multiplying the position-supplemented embedding vectors 1206 by a query weighting matrix W^{Q}. Similarly, the attention component 1208 produces key information K and value information V by multiplying the position-supplemented embedding vectors 1206 by a key weighting matrix W^{K} and a value weighting matrix W^{V}, respectively. To execute Equation (3), the attention component 1208 takes the dot product of Q with the transpose of K, and then divides the dot product by a scaling factor \sqrt{d}, to produce a scaled result. The symbol d represents the dimensionality of Q and K. The attention component 1208 takes the Softmax (normalized exponential function) of the scaled result, and then multiplies the result of the Softmax operation by V, to produce attention output information. In some cases, the attention component 1208 is said to perform masked attention insofar as the attention component 1208 masks output token information that, at any given time, has not yet been determined. General information regarding the general concept of attention is provided in Vaswani, et al., “Attention Is All You Need,” in 31st Conference on Neural Information Processing Systems (NIPS 2017), 2017, 11 pages.

Note that FIG. 12 shows that the attention component 1208 is composed of plural attention heads, including a representative attention head 1216. Each attention head performs the computations specified by Equation (3), but with respect to a particular representational subspace that is different than the subspaces of the other attention heads. To accomplish this operation, the attention heads perform the computations described above using different respective sets of query, key, and value weight matrices. Although not shown, the attention component 1208 concatenates the output results of the attention component's separate attention heads, and then multiplies the results of this concatenation by another weight matrix W^{O}.

The add-and-normalize component 1210 includes a residual connection that combines (e.g., sums) input information fed to the attention component 1208 with the output information generated by the attention component 1208. The add-and-normalize component 1210 then normalizes the output information generated by the residual connection, e.g., by layer-normalizing values in the output information based on the mean and standard deviation of those values, or by performing root-mean-squared normalization. The other add-and-normalize component 1214 performs the same functions as the first-mentioned add-and-normalize component 1210. The FFN component 1212 transforms input information to output information using a feed-forward neural network having any number of layers.

The first transformer component 1204 produces output information 1218. A series of other transformer components (1220, . . . , 1222) perform the same functions as the first transformer component 1204, each operating on output information produced by its immediately preceding transformer component. Each transformer component uses its own level-specific set of machine-trained weights. The final transformer component 1222 in the language model 1202 produces final output information 1224.

In some implementations, a post-processing component 1226 performs post-processing operations on the final output information 1224. For example, the post-processing component 1226 performs a machine-trained linear transformation on the final output information 1224, and processes the results of this transformation using a Softmax component (not shown). The language model 1202 uses the output of the post-processing component 1226 to predict the next token in the input sequence of tokens. In some applications, the language model 1202 performs this task using a greedy selection approach (e.g., by selecting the token having the highest probability), or by using the beam search algorithm (e.g., by traversing a tree that expresses a search space of candidate next tokens).

In some implementations, the language model 1202 operates in an auto-regressive manner, as indicated by the loop 1228. To operate in this way, the language model 1202 appends a predicted token to the end of the sequence of input tokens, to provide an updated sequence of tokens. The predicted token leads to the production of a new position-supplemented vector 1230. In a next pass, the language model 1202 processes the updated sequence of position-supplemented vectors to generate a next predicted token. The language model 1202 repeats the above process until it generates a specified stop token.

In other implementations (e.g., in the context of a BERT-based model), the post-processing component 1226 represents a classification head that produces a classification result in a single pass (non-autoregressively). In some implementations, the classification head is implemented by using a fully-connected feed-forward neural network or other type of feed-forward neural network having one or more layers followed by a Softmax component.

The above-described implementation of the language model 1202 relies on a decoder-only architecture. Other implementations of the language model 1202 use an encoder-decoder transformer-based architecture. Here, a transformer-based decoder receives encoder output information produced by a transformer-based encoder, together with decoder input information. The encoder output information specifically includes KV information that serves an input to the attention components of the decoder (except the first transformer component).

Other implementations of the language model 1202 use other kinds of machine-trained models besides, or in addition to, the particular transformer-based architecture shown in FIG. 12. The other machine-trained models include any of convolutional neural networks (CNNs), multilayer perceptrons (MLPs), recurrent neural networks (RNNs), stable diffusion models, selective state space models (e.g., Mamba-type models), etc., or any combination thereof.

### D. Illustrative Processes

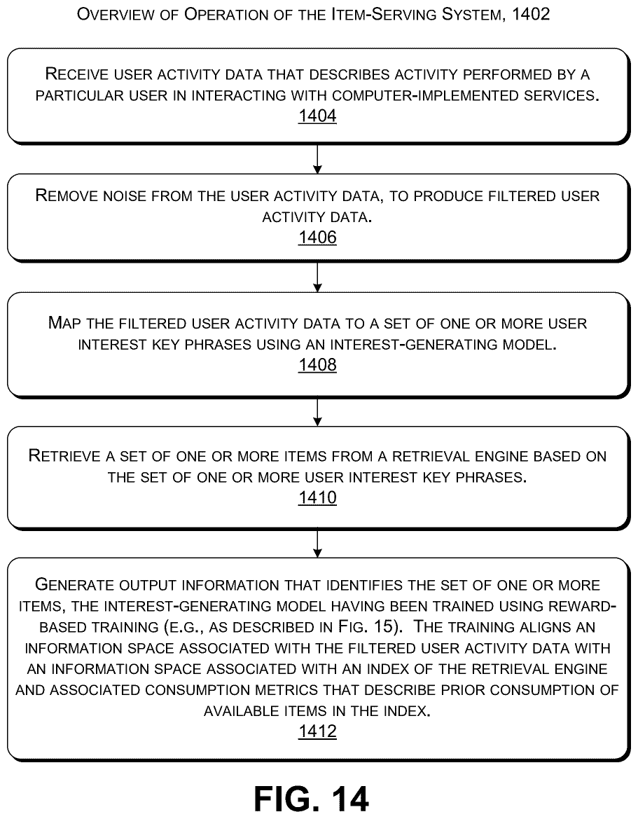

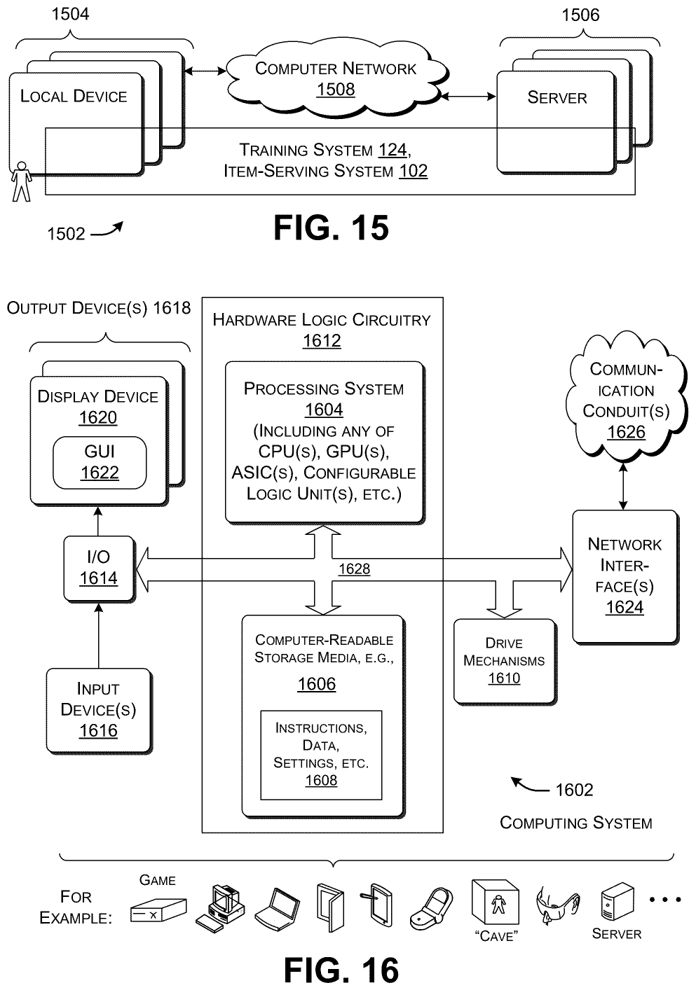

FIGS. 13 and 14 processes that represent an overview of the operation of the systems of FIG. 1. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 15 and 16.

More specifically, FIG. 13 shows a process 1302 that provides an overview of the operation of the training system 124 of FIG. 1. In block 1304, the training system 124 receives initial activity data from one or more data stores (e.g., data stores 114, 116, . . . , 118) that describes interactions with computer-implemented services (e.g., services 106). In block 1306, the training system 124 filters the initial activity data using a machine-trained filtering model (e.g., the filtering model 122) to remove a subset of the initial activity data that represents noise, to produce filtered activity data. In block 1308, the training system 124 maps the filtered activity data to a set of candidate IKPs. In block 1310, the training system 124 assigns scores to the candidate IKPs using a machine-trained reward system (e.g., the interest-generating model 126), to produce scored candidate IKPs, each score assigned to a particular candidate IKP describing an effectiveness of the particular candidate IKP in retrieving items from a retrieval engine (e.g., the retrieval engine 128) that will be selected when served. In block 1312, the training system 124 performs machine training of the interest-generated model based on the scored candidate IKPs. Upon completion of the training, the interest-generating model aligns an information space associated with the filtered activity data with an information space associated with an index (e.g., the index 130) of the retrieval engine and associated consumption metrics that describe prior consumption of available items in the index.

FIG. 14 shows a process 1402 that provides an overview of the operation of the item-serving system 102. In block 1404, the item-serving system 102 receives user activity data that describes activity performed by a particular user in interacting with computer-implemented services (e.g., services 106). In block 1406, the item-serving system 102 removes noise from the user activity data, to produce filtered user activity data. In block 1408, the item-serving system 102 maps the filtered user activity data to a set of one or more user IKPs using an interest-generating model (e.g., the interest-generating model 126). In block 1410, the item-serving system 102 retrieves a set of one or more items from a retrieval engine (e.g., the retrieval engine 128) based on the set of one or more user IKPs. In block 1412, the item-serving system 102 generates output information that identifies the set of one or more items. The interest-generating model has been trained using reward-based training that aligns an information space associated with the filtered user activity data with an information space associated with an index (e.g., the index 130) of the retrieval engine and associated consumption metrics that describe prior consumption of available items in the index.

### E. Illustrative Computing Devices and Systems

FIG. 15 shows computing equipment 1502 that, in some implementations, is used to implement the item-serving system 102 and the training system 124. The computing equipment 1502 includes a set of local devices 1504 coupled to a set of servers 1506 via a computer network 1508. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1508 is implemented as a local area network, a wide area network (e.g., the Internet), one or more point-to-point links, or any combination thereof.

The bottom-most overlapping box in FIG. 15 indicates that the functionality of the item-serving system 102 and training system 124 is capable of being spread across the local devices 1504 and/or the servers 1506 in any manner. For example, in one implementation, the item-serving system 102 is entirely implemented by a local device. In another example, the functions of the item-serving system 102 are entirely implemented by the servers 1506. Here, a user is able to interact with the servers 1506 via a browser application running on a local device. In other examples, some of the functions of the item-serving system 102 are implemented by a local device, and other functions of the item-serving system 102 are implemented by the servers 1506. In some implementations, for instance, the functions of the data-sampling component 120 and the filtering model 122 are implemented by a local device, and the remaining functions of the item-serving system 102 are implemented by the servers 1506. The functions of the training system 124 can likewise be implemented in different ways, e.g., entirely by the servers 1506, by one or more local devices, or by a combination of the servers 1506 and the local devices 1504.

FIG. 16 shows a computing system 1602 that, in some implementations, is used to implement any aspect of the mechanisms set forth in the above-described figures. For instance, in some implementations, the type of computing system 1602 shown in FIG. 16 is used to implement any local computing device or any server shown in FIG. 15. In all cases, the computing system 1602 represents a physical and tangible processing mechanism.

The computing system 1602 includes a processing system 1604 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1602 also includes computer-readable storage media 1606, corresponding to one or more computer-readable media hardware units. The computer-readable storage media 1606 retains any kind of information 1608, such as machine-readable instructions, settings, model weights, and/or other data. In some implementations, the computer-readable storage media 1606 includes one or more solid-state devices, one or more hard disks, one or more optical disks, etc. Any instance of the computer-readable storage media 1606 represents a fixed or removable unit of the computing system 1602. Further, any instance of the computer-readable storage media 1606 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1602 utilizes any instance of the computer-readable storage media 1606 in different ways. For example, in some implementations, any instance of the computer-readable storage media 1606 represents a hardware memory unit (such as random access memory (RAM)) for storing information during execution of a program by the computing system 1602, and/or a hardware storage unit (such as a hard disk) for retaining/archiving information on a more permanent basis. In the latter case, the computing system 1602 also includes one or more drive mechanisms 1610 (such as a hard drive mechanism) for storing and retrieving information from an instance of the computer-readable storage media 1606.

In some implementations, the computing system 1602 performs any of the functions described above when the processing system 1604 executes computer-readable instructions stored in any instance of the computer-readable storage media 1606. For instance, in some implementations, the computing system 1602 carries out computer-readable instructions to perform each block of the processes described with reference to FIGS. 13 and 14. FIG. 16 generally indicates that hardware logic circuitry 1612 includes any combination of the processing system 1604 and the computer-readable storage media 1606.

In addition, or alternatively, the processing system 1604 includes one or more other configurable logic units that perform operations using a collection of logic gates, such as field-programmable gate arrays (FPGAs), etc. In these implementations, the processing system 1604 effectively incorporates a storage device that stores computer-readable instructions, insofar as the configurable logic units are configured to execute the instructions and therefore embody or store these instructions.

In some cases (e.g., in the case in which the computing system 1602 represents a user computing device), the computing system 1602 also includes an input/output interface 1614 for receiving various inputs (via input devices 1816), and for providing various outputs (via output devices 1818). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1820 and an associated graphical user interface presentation (GUI) 1822. The display device 1820 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1802 also includes one or more network interfaces 1824 for exchanging data with other devices via one or more communication conduits 1826. One or more communication buses 1828 communicatively couple the above-described units together.

The communication conduit(s) 1826 is implemented in any manner, e.g., by a local area computer network, a wide area computer network (e.g., the Internet), point-to-point connections, or any combination thereof. The communication conduit(s) 1826 include any combination of hardwired links, wireless links, routers, gateway functionality, name servers, etc., governed by any protocol or combination of protocols.

FIG. 18 shows the computing system 1802 as being composed of a discrete collection of separate units. In some cases, the collection of units corresponds to discrete hardware units provided in a computing device chassis having any form factor. FIG. 18 shows illustrative form factors in its bottom portion. In other cases, the computing system 1802 includes a hardware logic unit that integrates the functions of two or more of the units shown in FIG. 18. For instance, in some implementations, the computing system 1802 includes a system on a chip (SoC or SOC), corresponding to an integrated circuit that combines the functions of two or more of the units shown in FIG. 18.

The following summary provides a set of illustrative examples of the technology set forth herein.
(A1) According to one aspect, a method is described for training an interest-generating model (e.g., the interest-generating model 126). The method includes: receiving (e.g., in block 1304) initial activity data from one or more data stores (e.g., the data stores 114, 116, 118) that describes interactions with one or more computer-implemented services (e.g., the computer-implemented services 106); filtering (e.g., in block 1306) the initial activity data using a machine-trained filtering model (e.g., the filtering model 122) to remove a subset of the initial activity data that represents noise, to produce filtered activity data; mapping (e.g., in block 1308) the filtered activity data to a set of candidate interest key phrases; assigning (e.g., in block 1310) scores to the candidate interest key phrases using a machine-trained reward system (e.g., the reward system 212), to produce scored candidate interest key phrases, each score assigned to a particular candidate interest key phrase describing an effectiveness of the particular candidate interest key phrase in retrieving items from a retrieval engine (e.g., the retrieval engine 128) that will be selected when served; and performing (e.g., 1312) reward-based training of the interest-generated model based on the scored candidate interest key phrases. Upon completion of the reward-based training, the interest-generating model aligns an information space associated with the filtered activity data with an information space associated with an index (e.g., the index 130) of the retrieval engine and associated consumption metrics that describe prior consumption of available items in the index.
(A2) According to one illustrative aspect of A1, the initial activity data provides information regarding queries submitted to the one or more computer-implemented services.
(A3) According to one illustrative aspect of A2, the initial activity data also provides information regarding items that were provided by the one or more computer-implemented services and were then selected by users.
(A4) According to some illustrative aspects of any of A1-A3, the machine-trained reward system includes plural reward models. The score assigned to the particular candidate interest key phrase is based on a combination of plural sub-scores produced by the reward models.
(A5) According to some illustrative aspects of A4, one reward model is trained by: producing a plurality of training examples, a particular training example of the plurality of training examples being associated with the particular candidate key phrase; and training the reward model based on the training examples. The particular example is produced by: identifying one or more items that match the particular candidate interest key phrase; and generating an engagement score that describes prior engagement with the one or more items, wherein the particular training example includes the particular candidate interest key phrase and the engagement score.
(A6) According to some illustrative aspects of A5, the prior engagement is measured by one or more engagement metrics that describe one or more respective click-through-rates associated with the one or more items.
(A7) According to some illustrative aspects of A4, one reward model is trained by: producing a plurality of training examples, a particular training example of the plurality of training examples being associated with the particular candidate key phrase; and training the reward model based on the training examples. The particular example is produced by: identifying one or more items that match the particular candidate interest key phrase; and generating a semantic score that describes semantic agreement between the particular candidate interest key phrase and the one or more items, wherein the particular training example includes the particular candidate interest key phrase and the semantic score.
(A8) According to some illustrative aspects of A4, one reward model is trained by: producing a plurality of training examples, a particular training example of the plurality of training examples being associated with the particular candidate key phrase; and training the reward model based on the training examples. The particular example is produced by assigning a noise score to the particular candidate interest key phrase that reflects a likelihood that the candidate interest key phrase represents noise, wherein the particular training example includes the particular candidate interest key phrase and the noise score.
(A9) According to some illustrative aspects of A1, the reward-based training includes: grouping the candidate interest key phrases into semantic groups, each of the semantic groups describing a subset of candidate interest key phrases associated with a semantic category; selecting samples from the semantic groups; producing training examples based on the samples that are selected; and training the interest-generating model based on the training examples.
(A10) According to illustrative aspects of any of A1-A9, the reward-based training performs direct preference optimization (DPO), and wherein the samples include, for each semantic group, a positive sample having a first reward score, and negative sample having a second score that differs from the first score.
(A11) According to illustrative implementations of any of A1-A9, the reward-based training performs proximal policy optimization (PPO).
(A12) According to illustrative implementations of any of A1-A11, the interest-generating model is a language model.
(A13) According to illustrative implementations of any of A1-A12, the interest-generating model, once trained, is used in an item-serving system, the item-serving system operating by: receiving user activity data that describes activity performed by a particular user in interacting with the one or more computer-implemented services; removing noise from the user activity data, to produce filtered user activity data; mapping the filtered user activity data to a set of one or more user interest key phrases using the interest-generating model; retrieving a set of one or more items from the retrieval engine based on the set of one or more user interest key phrases; and generating output information that identifies the set of one or more items.
(B1) According to another illustrative aspect, a method (e.g., process 1402) is described for retrieving items. The method includes: receiving (e.g., in block 1404) user activity data that describes activity performed by a particular user in interacting with one or more computer-implemented services (e.g., computer-implemented services 106); removing (e.g., in block 1406) noise from the user activity data, to produce filtered user activity data; mapping (e.g., in block 1408) the filtered user activity data to a set of one or more user interest key phrases using an interest-generating model (e.g., the interest-generating model 126); retrieving (e.g., in block 1410) a set of one or more items from a retrieval engine (e.g., the retrieval engine 128) based on the set of one or more user interest key phrases; and generating (e.g., in block 1412) output information that identifies the set of one or more items. The interest-generating model is trained using reward-based training that aligns an information space associated with the filtered user activity data with an information space associated with an index (e.g., the index 130) of the retrieval engine and associated consumption metrics that describe prior consumption of available items in the index.

In yet another aspect, some implementations of the technology described herein include a computing system (e.g., the computing system 1802) that includes a processing system (e.g., the processing system 1804) having a processor. The computing system also includes a storage device (e.g., the computer-readable storage media 1806) for storing computer-readable instructions (e.g., the information 1808). The processing system executes the computer-readable instructions to perform any of the methods described herein (e.g., any individual method of the methods of A1-A13 or B1).

In yet another aspect, some implementations of the technology described herein include a computer-readable storage medium (e.g., the computer-readable storage media 1806) for storing computer-readable instructions (e.g., the information 1808). A processing system (e.g., the processing system 1804) executes the computer-readable instructions to perform any of the operations described herein (e.g., the operations in any individual method of the methods of A1-A13 or B1).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1812 of FIG. 18. The term “logic” likewise encompasses various physical and tangible mechanisms for performing a task. For instance, each processing-related operation illustrated in the flowcharts of FIGS. 13 and 14 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for training an interest-generating model, comprising:
receiving initial activity data from one or more data stores that describes interactions with one or more computer-implemented services;
filtering the initial activity data using a machine-trained filtering model to remove a subset of the initial activity data that represents noise, to produce filtered activity data;
mapping the filtered activity data to a set of candidate interest key phrases;
assigning scores to the candidate interest key phrases using a machine-trained reward system, to produce scored candidate interest key phrases, each score assigned to a particular candidate interest key phrase describing an effectiveness of the particular candidate interest key phrase in retrieving items from a retrieval engine that will be selected when served; and
performing reward-based training of the interest-generated model based on the scored candidate interest key phrases,
upon completion of the reward-based training, the interest-generating model aligning an information space associated with the filtered activity data with an information space associated with an index of the retrieval engine and associated consumption metrics that describe prior consumption of available items in the index.

2. The method of claim 1, wherein the initial activity data provides information regarding queries submitted to the one or more computer-implemented services.

3. The method of claim 2, wherein the initial activity data also provides information regarding items that were provided by the one or more computer-implemented services and were then selected by users.

4. The method of claim 1, wherein the machine-trained reward system includes plural reward models, and wherein the score assigned to the particular candidate interest key phrase is based on a combination of plural sub-scores produced by the reward models.

5. The method of claim 4, wherein one reward model is trained by:
producing a plurality of training examples, a particular training example of the plurality of training examples being associated with the particular candidate key phrase,
the particular example being produced by: identifying one or more items that match the particular candidate interest key phrase; and generating an engagement score that describes prior engagement with the one or more items, wherein the particular training example includes the particular candidate interest key phrase and the engagement score; and
training the reward model based on the training examples.

6. The method of claim 5, wherein the prior engagement is measured by one or more engagement metrics that describe one or more respective click-through-rates associated with the one or more items.

7. The method of claim 4, wherein one reward model is trained by:
producing a plurality of training examples, a particular training example of the plurality of training examples being associated with the particular candidate key phrase,
the particular example being produced by: identifying one or more items that match the particular candidate interest key phrase; and generating a semantic score that describes semantic agreement between the particular candidate interest key phrase and the one or more items, wherein the particular training example includes the particular candidate interest key phrase and the semantic score; and
training the reward model based on the training examples.

8. The method of claim 4, wherein one reward model is trained by:
producing a plurality of training examples, a particular training example of the plurality of training examples being associated with the particular candidate key phrase,
the particular example being produced by assigning a noise score to the particular candidate interest key phrase that reflects a likelihood that the candidate interest key phrase represents noise, wherein the particular training example includes the particular candidate interest key phrase and the noise score; and
training the reward model based on the training examples.

9. The method of claim 1, wherein the reward-based training includes:
grouping the candidate interest key phrases into semantic groups, each of the semantic groups describing a subset of candidate interest key phrases associated with a semantic category;
selecting samples from the semantic groups;
producing training examples based on the samples that are selected; and
training the interest-generating model based on the training examples.

10. The method of claim 1, wherein the reward-based training performs direct preference optimization (DPO), and wherein the samples include, for each semantic group, a positive sample having a first reward score, and negative sample having a second score that differs from the first score.

11. The method of claim 1, wherein the reward-based training performs proximal policy optimization (PPO).

12. The method of claim 1, wherein the interest-generating model is a language model.

13. The method of claim 1, wherein the interest-generating model, once trained, is used in an item-serving system, the item-serving system operating by:
receiving user activity data that describes activity performed by a particular user in interacting with the one or more computer-implemented services;
removing noise from the user activity data, to produce filtered user activity data;
mapping the filtered user activity data to a set of one or more user interest key phrases using the interest-generating model;
retrieving a set of one or more items from the retrieval engine based on the set of one or more user interest key phrases; and
generating output information that identifies the set of one or more items.

14. A computing system for retrieving items, comprising:
an instruction data store for storing computer-readable instructions; and
a processing system for executing the computer-readable instructions in the data store, to perform operations including:
receiving user activity data that describes activity performed by a particular user in interacting with one or more computer-implemented services;
removing noise from the user activity data, to produce filtered user activity data;
mapping the filtered user activity data to a set of one or more user interest key phrases using an interest-generating model;
retrieving a set of one or more items from a retrieval engine based on the set of one or more user interest key phrases; and
generating output information that identifies the set of one or more items,
wherein the interest-generating model has been trained using reward-based training that aligns an information space associated with the filtered user activity data with an information space associated with an index of the retrieval engine and associated consumption metrics that describe prior consumption of available items in the index.

15. The computing system of claim 14, wherein the user activity data describes queries submitted to the one or more computer-implemented services and/or selections of items.

16. The computing system of claim 14, wherein the reward-based training includes:
receiving initial group activity data from one or more data stores that describes interactions with one or more computer-implemented services by a group of users;
filtering the initial group activity data using a machine-trained filtering model to remove a subset of initial group activity data that represents noise, to produce filtered group activity data;
mapping the filtered group activity data to a set of candidate interest key phrases;
assigning scores to the candidate interest key phrases using a machine-trained reward system, to produce scored candidate interest key phrases, each score assigned to a particular candidate interest key phrase describing an effectiveness of the particular candidate interest key phrase in retrieving items from a retrieval engine that will be selected when served; and
performing machine training of the interest-generated model based on the scored candidate interest key phrases.

17. The computing system of claim 16, wherein the machine-trained reward system includes plural reward models, and wherein the machine-trained reward system assigns a score to the particular candidate interest key phrase that is based on a combination of respective sub-scores produced by the reward models.

18. The computing system of claim 17,
wherein a first reward model produces a reward sub-score for the particular candidate interest key phrase that describes a level of engagement by users with one or more items that match the particular candidate interest key phrase,
wherein a second reward model produces a reward sub-score for the particular candidate interest key phrase that describes semantic agreement between the particular candidate interest key phrase and one more available items that match the candidate interest key phrase, and
wherein a third reward model produces a reward sub-score for the particular candidate interest key phrase that describes a likelihood that the particular candidate interest key phrase represents noise.

19. The computing of claim 16, wherein the reward-based training includes:
grouping the candidate interest key phrases into semantic groups, each of the semantic groups describing a subset of candidate interest key phrases associated with a semantic category;
identifying samples from the semantic groups;
producing training examples based on the samples; and
training the interest-generating model based on the training examples.

20. A computer-readable storage medium for storing computer-readable instructions, a processing system executing the computer-readable instructions to perform operations, the operations comprising:
receiving initial activity data from one or more data stores that describes interactions with one or more computer-implemented services;
filtering the initial activity data using a machine-trained filtering model to remove a subset of the initial activity data that represents noise, to produce filtered activity data;
mapping the filtered activity data to a set of candidate interest key phrases;
assigning scores to the candidate interest key phrases using a machine-trained reward system, to produce scored candidate interest key phrases, each score assigned to a particular candidate interest key phrase describing an effectiveness of the particular candidate interest key phrase in retrieving items from a retrieval engine that will be selected when served; and
grouping the candidate interest key phrases into semantic groups, each of the semantic groups describing a subset of candidate interest key phrases associated with a semantic category;
identifying samples from the semantic groups;
producing training examples based on the samples; and
training the interest-generating model based on the training examples using reward-based training.
